(19) United States
(12) Patent Application Publication
(10) Pub. No.: US 2015/0293380 A1
(43) Pub. Date: Oct. 15, 2015

(54) Method Of Manufacturing An Optical Lens

(71) Applicant: ESSILOR INTERNATIONAL (COMPAGNIE GENERALE D'OPTIQUE), Charenton-le-pont (FR)

(72) Inventors: Alexandre Gourraud, Charenton Le Pont (FR); Eric Gacoin, Charenton le Pont (FR); Pascal Le Bouillonnec, Charenton le Pont (FR)

(73) Assignee: ESSILOR INTERNATIONAL (COMPAGINE GENERALE D'OPTIQUE), Charenton le Pont (FR)

(21) Appl. No.: 14/443,320

(22) PCT Filed: Oct. 30, 2013
(86) PCT No.: PCT/EP2013/072732

§ 371 Date: May 15, 2015

(30) Foreign Application Priority Data
Nov. 19, 2012 (EP) 12306433.9

(51) Int. Cl. G02C 13/00; G05B 19/18

(52) U.S. Cl. CPC G02C 13/001; G05B 19/182; G05B 2219/45157

(57) ABSTRACT

Method of manufacturing an optical lens, the method comprising: a lens member providing step (S1) during which a lens member comprising a first surface and a first reference system identified by first markings on the first surface is provided, a surface data providing step (S2) during which surface data corresponding to a second surface and the position of the second surface relative to the first surface of the optical lens are provided, a blocking and machining step during which the lens member is blocked and the second surface is machined, a second markings determining an providing step (S4) during which second markings identifying a second reference system of the second surface are determined and provided according at least to optical data representing the refractive properties of the optical lens and to observation data representing observation conditions in which the first and second markings are to be observed.

### RELATED APPLICATIONS

This is a U.S. national stage under 35 USC §371 of application No. PCT/EP2013/072732, filed on Oct. 30, 2013. This application claims the priority of European application no. 12306433.9 filed Nov. 19, 2012, the entire content of which is hereby incorporated by reference.

### FIELD OF THE INVENTION

The invention relates to a method of manufacturing an optical lens and a method for controlling a lens manufacturing method.

### BACKGROUND OF THE INVENTION

The discussion of the background of the invention herein is included to explain the context of the invention. This is not to be taken as an admission that any of the material referred to was published, known or part of the common general knowledge at the priority date of any of the claims.

An optical lens is typically made of plastic material and generally has two opposing surfaces which co-operate with one another to provide a required refractive property, generally corresponding to the wearer's prescription. When the positioning or shape of one of these surfaces with respect to the other is inaccurate, the required refractive property may not be respected.

Manufacturing of an optical lens to the required refractive property typically includes machining the surface of a semi-finished lens or lens blank. Typically, a semi-finished lens has a finished surface, for example the front surface and an unfinished surface, for example the back surface. By machining the back surface of the lens to remove material, the required shape and positioning of the back surface with respect to the front surface for the desired corrective prescription can be generated.

During manufacturing of the lens it is important that the semi-finished lens is securely maintained in an accurate position on a blocker during the various manufacturing operations in order to prevent the generation of optical errors.

Conventionally, a semi-finished lens is provided with engraved markings on the finished surface. The engraved markings define a reference system of the design of the finished surface of the lens.

For some optical designs, for example when both surfaces have asymmetrical designs, controlling accurately the relative position of the optical surfaces is very important so as to guarantee the desired optical function.

When after having manufactured an optical lens, a skilled person wishes to check the relative positions of the optical surfaces of the manufactured optical lens; he needs to realize a full optical function measurement or a 3D surfaces measurement of the optical lens. These methods are very time consuming and costly.

### SUMMARY OF THE INVENTION

Therefore, there is a need for a method of manufacturing an optical lens that allows an easy check of the relative position of the optical surfaces of the manufactured optical lens.

To this end, one aspect of the invention is directed to a method of manufacturing an optical lens, the method comprising:
a lens member providing step during which a lens member comprising a first surface and a first reference system of the first surface is provided, the first reference system being identified by first markings on the first surface,
a surface data providing step during which surface data corresponding to a second surface and the position of the second surface relative to the first surface of the optical lens to be manufactured are provided,
a lens member blocking step during which the lens member is blocked in a machining position,
a machining step during which the second surface of the optical lens is machined according to the surface data,
a second markings determining step during which second markings identifying a second reference system of the second surface are determined according at least to optical data representing the refractive properties of the optical lens and to observation data representing observation conditions in which the first and second markings are to be observed, and
a second markings providing step during which the second markings are provided on the second surface of the optical lens.

Advantageously, the second markings being determined according to the refractive properties of the optical lens and the observation condition, checking the accuracy of the relative position of the first and second surfaces in the observation condition may be rendered straight forward.

According to further embodiments which can be considered alone or in combination:

the method further comprises:
a reference system determining step during which the first and second reference systems are determined by determining the positions of the first and second markings in the observation conditions corresponding to the observation data, and
a comparison step during which the positions of the first and second reference systems are compared so as to determine the positioning error between the first and second surfaces; and/or

the method further comprises a sorting step during which the manufactured optical lens is accepted if the positioning error between the first and second surfaces is smaller than or equal to a threshold value and is set aside if the positioning error between the first and second surfaces is greater than said threshold value; and/or

during the determining step the positions on the first and second markings are measured using a measuring optical device and the observation data represents at least the position of the optical lens relative to the measuring optical device; and/or

during the determining step, the relative position between the first and second markings is determined in the observation conditions by an operator; and/or

during the second marking determining step the second markings are determined so as to appear at the same position as the first markings in the observation conditions when the second surface is correctly positioned relatively to the first surface; and/or

during the second marking determining step the second markings are determined so as to take into account a positioning error tolerance; and/or

the optical data represent at least the design of the first and second surfaces and the relative position of the second surface relative to the first surface; and/or

during the second markings providing step the optical lens is blocked in the same position as during the machining step; and/or

the first and/or second markings are temporary markings; and/or

the optical data represent at least the prescription of the wearer for which the optical lens is manufactured.

Another aspect of the invention relates to a method for controlling a lens manufacturing method comprising:
an optical lens manufacturing step during which an optical lens is manufactured according to a manufacturing method according to the invention using a manufacturing device,
a positioning error determining step during which the positioning error of the first and second surfaces of the optical lens is determined,
a recording step during which the positioning error is recorded,
wherein, the method further comprises repeating regularly optical lens manufacturing, positioning error determining and recording steps and checking the evolution of the positioning error over time, and
the evolution of at least one parameter of the manufacturing device used during the lens manufacturing process is checked over time and the evolution over time of the positioning error of the first and second surfaces of the optical lens is related with the evolution over time of the at least one parameter of the manufacturing device.

Another aspect of the invention relates to a method for controlling a lens manufacturing method comprising:
a master lens manufacturing step during which a master lens is manufactured according to a manufacturing method as claimed in any of claims 1 to 10 using a manufacturing device,
a positioning error determining step during which the positioning error of the first and second surfaces of the master lens is determined,
a recording step during which the positioning error is recorded,
wherein, the method further comprises repeating regularly master lens manufacturing, positioning error determining and recording steps and checking the evolution of the positioning error over time, and
   the evolution of at least one parameter of the manufacturing device used during the lens manufacturing process is checked over time and the evolution over time of the positioning error of the first and second surfaces of the master lens is related with the evolution over time of the at least one parameter of the manufacturing device.

According to a further aspect, the invention relates to a computer program product comprising one or more stored sequences of instructions that are accessible to a processor and which, when executed by the processor, causes the processor to carry out the steps of the method according to an embodiment of the invention.

Another aspect of the invention relates to a computer readable medium carrying one or more sequences of instructions of the computer program product according to an embodiment of the invention.

Another aspect of the invention relates to a program which makes a computer execute the method according to an embodiment of the invention.

Another aspect of the invention relates to a computer-readable storage medium having a program recorded thereon; where the program makes the computer execute the method according to an embodiment of the invention.

Another aspect of the invention relates to a device comprising a processor adapted to store one or more sequence of instructions and to carry out at least one of the steps of the method according to an embodiment of the invention.

Unless specifically stated otherwise, as apparent from the following discussions, it is appreciated that throughout the specification discussions utilizing terms such as “computing”, “calculating”, “generating”, or the like, refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

Embodiments of the present invention may include apparatuses for performing the operations herein. This apparatus may be specially constructed for the desired purposes, or it may comprise a general purpose computer or Digital Signal Processor (“DSP”) selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs) electrically programmable read-only memories (EPROMs), electrically erasable and programmable read only memories (EEPROMs), magnetic or optical cards, or any other type of media suitable for storing electronic instructions, and capable of being coupled to a computer system bus.

The processes and displays presented herein are not inherently related to any particular computer or other apparatus. Various general purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the inventions as described herein.

### BRIEF DESCRIPTION OF THE DRAWINGS

Non limiting embodiments of the invention will now be described with reference to the accompanying drawings in which:

FIG. 1 is flowchart representing the steps of a method according to an embodiment of the invention,

FIG. 2A is schematic view of an optical lens member to be manufactured according to embodiments of the invention,

FIG. 2B is a planar view of a preformed surface of a semi-finished lens member to be machined according to embodiments of the invention,

FIG. 3 is a schematic representation of a lens member and blocking device, and

FIG. 4A to 4C are schematic representation of optical lenses manufactured according to the invention.

### DETAILED DESCRIPTION OF THE DRAWINGS

Elements in the figures are illustrated for simplicity and clarity and have not necessarily been drawn to scale. For example, the dimensions of some of the elements in the figure may be exaggerated relative to other elements to help improve the understanding of the embodiments of the present invention.

In the sense of the invention, a “Design” is a widely used wording known from the man skilled in the art to designate the set of parameters allowing defining an optical function of a generic optical system; each ophthalmic lens manufacturer has its own designs, particularly for aspherical lens and for progressive lens. As for an example, a progressive lens “design” results of an optimization of the progressive surface so as to restore a presbyope's ability to see clearly at all distances but also to optimally respect all physiological visual functions such as foveal vision, extra-foveal vision, binocular vision and to minimize unwanted astigmatisms.

In the sense of the invention “manufacturing parameters” are the setting parameters of the different manufacturing devices involved in the manufacturing method. In the sense of the invention “method parameter” includes any measurable parameters on the manufacturing devices used for the manufacturing of the lens.

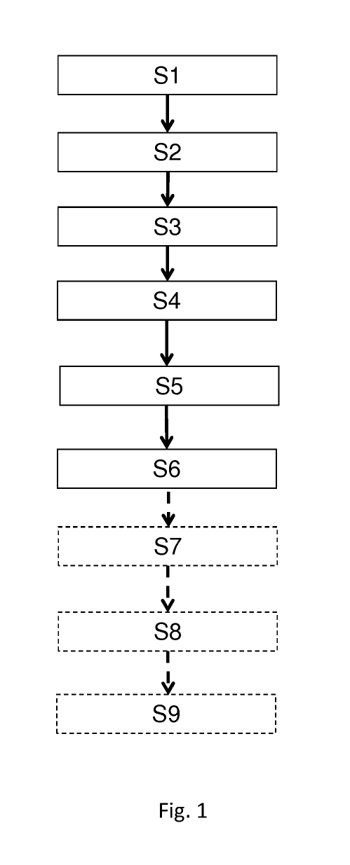

According to an embodiment of the invention illustrated on FIG. 1, the method of manufacturing an optical lens according to the invention comprises at least:
a lens member providing step S1,
a surface data providing step S2,
a lens member blocking step S3,
a machining step S4,
a second markings determining step S5, and
a second markings providing step S6.

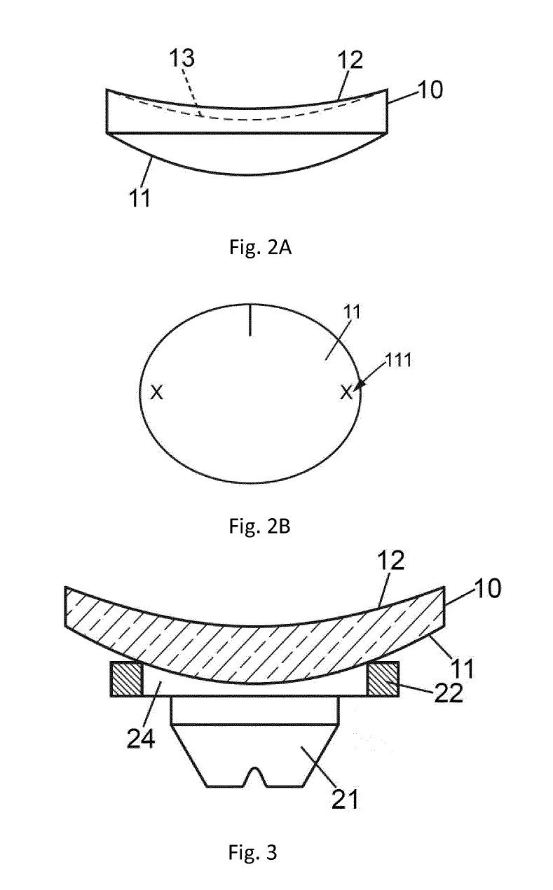

During the lens member providing step S1, a lens member as represented on FIG. 2A is provided.

As represented on FIG. 2A the lens member 10 has a first surface with a first design, for example a preformed front surface 11. In use of the resulting finished optical lens, the preformed front surface 11 is disposed nearest the object being viewed and a second surface 12 to be modified by the manufacturing process to provide for example the back surface 13 of the finished optical lens, represented by the dotted line. Second surface 12 is machined by a machining tool so that the back surface 13 is orientated with respect to and distanced from the front surface 11, according to the required optical prescription.

While in this embodiment of the invention, the first surface is the front surface of the lens member and the second surface is the back surface, it will be understood, that in alternative embodiments of the invention the first surface may be the back surface of the semi-finished lens member and the second surface may be the front surface.

Furthermore, while in this embodiment of the invention, the back surface of the optical lens is formed by the machining process, it will be understood, that in alternative embodiments of the invention both or either surfaces of the lens may be formed by the machining process.

Moreover, although the surface 13 to be manufactured is represented in FIG. 2A as concave, it will be appreciated that this surface 13 could equally well be convex or any other curved surface.

With reference to FIG. 2B, first markings 111 are provided on the first surface 11 of lens member 10 as reference features for defining a first reference system for positioning of the first design of the first surface 11.

According to an embodiment of the invention, the markings 111 may be engraved marking have a depth of a few micrometers so as to limit the risk of disturbing the wearer of the resulting finished optical lens.

According to an alternative embodiment of the invention, the markings 11 may be temporary markings that may be remove before providing the manufactured optical lens to the wearer.

During the surface data providing step S2, surface data corresponding to a second surface of the optical lens to be manufactured are provided. The surface data correspond to the surface to be manufactured on the second surface 12 and the position of the second surface relative to the first surface so that the optical lens combining the manufactured back surface 13 and the front surface provides the required optical function. The surface data can be determined according to the front preformed surface and the wearer's prescription.

During the lens member blocking step S3, the lens member 10 is blocked in a machining position. During the machining step S4 the second surface of the optical lens is machined according to the surface data such that the desired optical properties of the optical lens are respected.

According to an embodiment of the invention, the method may comprise prior to the lens member blocking step S3 a lens blocker providing step.

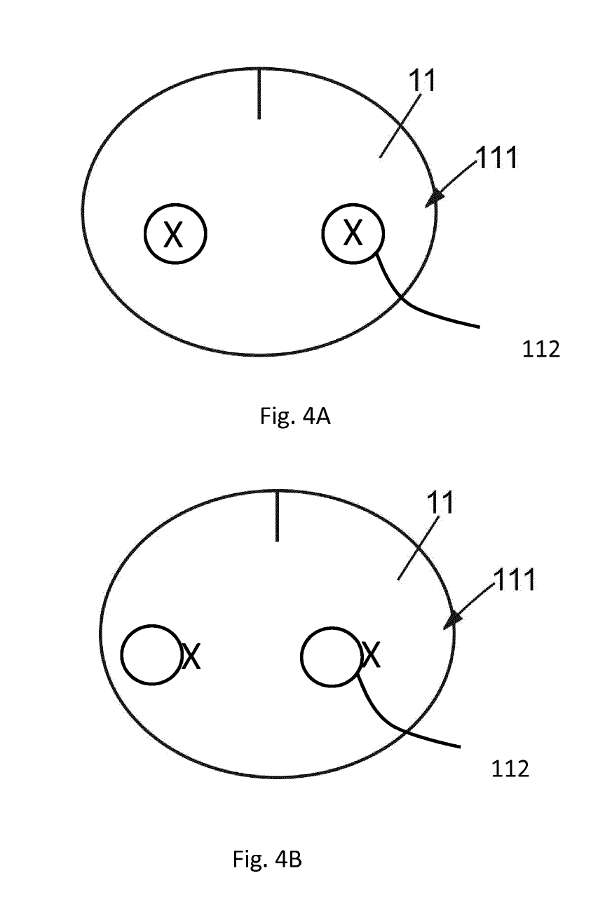

Referring now to FIG. 3, a lens blocking device for blocking lens member 10 in the correct position for manufacturing processes comprises an insert 21 and a blocking ring 22. Blocking cast material 24 is poured into the cavity defined by the lower surface of the lens member 10, the insert 21 and the blocking ring 22. The blocking cast material 24 cools to solidify in order to provide a blocker for the lens member 10 at the desired positioning for machining. The blocker comprises the machining reference frame in which the machining data are expressed.

During the second markings determining step S5 second markings identifying a second reference system of the second surface are determined. The second markings are provided on the second surface of the optical lens during the second markings providing step S6.

The second markings are determined at least according to optical data and observation data.

The optical data represent the refractive properties of the optical lens. According to an embodiment of the invention, the optical data represent the prescription of the wearer. The optical data may represent the design of the first and second surfaces, the position of the second relative to the first surface, for example, the thickness and prism of the optical lens and the optical index.

The observation data represent observation conditions in which the first and second markings are to be observed. The observation conditions may be defined by considering the observation device and the position of the manufactured lens in the observation device. The position of the manufactured optical lens in the observation device may be defined as the position of an optical lens reference frame and an observation device reference frame. The optical lens reference frame can be defined using the blocker if the lens has been maintained on the blocker, or by the normal to one of the surfaces of the optical lens passing through the prism reference point as defined by a harmonized standard ISO 8980.

Advantageously, determining the relative positions of the two surfaces is rendered much easier, in particular when the observation of the first and second markings is realized in the observation conditions.

According to an embodiment of the invention, the second markings are determined so as to appear at the same position as the first markings in the observation conditions when the second surface is correctly positioned relatively to the first surface. Therefore, in the observation condition the second and first markings appear superimposed when the second surface is correctly positioned relatively to the first surface.

Therefore, a sorting of the manufactured optical lenses can be easily implemented.

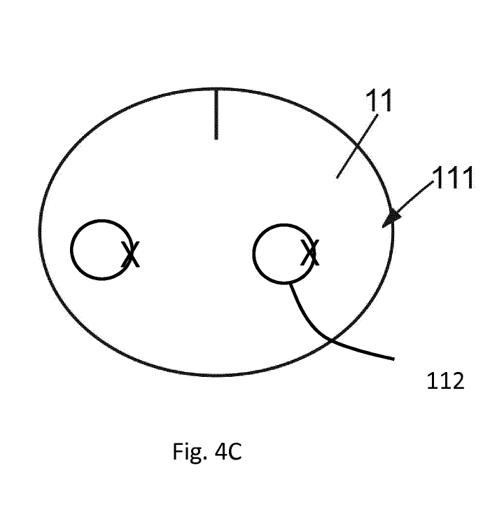

According to an embodiment of the invention illustrated on FIGS. 4A and 4B, the second markings may be determined so as to take into account a positioning error tolerance.

For example as illustrated on FIG. 4A, the second markings 112 may have circular shapes and be determined so as to appear centered over the first markings 111 in the observing conditions when the second surface is correctly positioned relatively to the first surface. The radius of the circular shaped second markings may be determined based on an error position tolerance.

Therefore, when the positioning error of the second and first surfaces is greater than the error position tolerance, the first markings appear outside the second markings, as illustrated on FIG. 4B.

However, when the positioning error of the second and first surfaces is smaller than the error position tolerance, the first markings appear inside the second markings, as illustrated on FIG. 4C.

According to an embodiment of the invention, the second markings providing step is realized with the same machining device as the machining step and the optical lens is maintained in same position. Advantageously, having the optical lens maintained in the same position during the machining and second markings providing steps guaranties that no positioning error is introduced between the second markings and the second surface.

As illustrated on FIG. 1, according to an embodiment of the invention, the method may further comprise after the second marking providing step:
a reference system determining step S7, and
a comparison step S8.

Advantageously, these additional steps allow determining the relative position of the first and second surface of the machined optical lens.

During the reference system determining step S7, the positions of the first and second markings are determined in the observation conditions corresponding to the observation data. The first and second reference systems can be determined based on the positions of the first and second markings.

The positioning error between the first and second surfaces is determined by comparing the positions of the first and second reference systems during the comparison step S8.

According to an embodiment of the invention, the positions of the first and second reference systems are compared in a common reference system, for example in the manufactured optical lens reference frame. As indicated previously, the optical lens reference frame can be defined using the blocker if the lens has been maintained on the blocker, or by the normal to one of the surfaces of the optical lens passing between the reference-markings that have been made mandatory by a harmonized standard ISO 8980.

According to an embodiment of the invention, the relative position between the first and second markings is determined in the observation condition by an operator. For example, the observation condition may consist in placing the optical lens at a predetermined distance of a light source and of the operator's eye. During the second markings determining step, the second markings may be determined so as to appear to the operator superimposed with the first marking when the second surface is correctly positioned relative to the first surface or as illustrated on FIGS. 4a to 4C with an error tolerance.

Advantageously, the operator may very easily check the relative position of the first and second surfaces.

The observation condition could also be having an image of a light source be projected on to a screen through the machined optical lens. The operator could then observe the markings on the projection screen.

As illustrated on FIG. 1, the method according to the invention may also comprise a sorting step S9, during which the manufactured optical lens is accepted if the positioning error between the first and second surfaces is smaller than or equal to a threshold value and is set aside if the positioning error between the first and second surfaces is greater than said threshold value.

According to different embodiments of the invention, the threshold value may depend on the prescription of the wearer and/or the design of one or both surfaces and/or the curvature variations of one or both of the surfaces.

The invention also relates to a method for controlling a lens manufacturing process. The method for controlling a lens manufacturing process comprises the steps of:
a) manufacturing an optical lens according to a manufacturing method of the invention using a manufacturing device,
b) determining the positioning error of the first and second surfaces of the optical lens,
c) recording the determined positioning error,
d) repeating regularly step a) to c) and checking over time the evolution of the positioning error.

The evolution of at least one parameter of the manufacturing device used during the lens manufacturing process is checked over time and the evolution over time of the positioning error of the first and second surfaces of the optical lens is related with the evolution over time of the at least one parameter of the manufacturing device.

Advantageously, the method according to the invention allows controlling certain method or device parameters of the machining process. Indeed, the position error can be correlated to some of the machining device parameters, thus controlling the evolution over time of the positioning error can help identify a drift or shift of a machining device parameter.

According to an embodiment of the invention, the optical lenses manufactured when repeating step a) may be different optical lenses from one repetition to the other.

According to an embodiment of the invention the optical lens manufactured during step a) may be a master lens.

The master lens has a different geometrical and/or optical parameter and/or is made of a different material than the lenses to be manufactured during the manufacturing process.

The choice of the master lens can be done so as to simplify the observation conditions, for example the master lens may comprise two plane and parallel surfaces.

The choice of the master lens can be done so as to amplify the sensibility of certain parameter to the process parameters. For example, the master lens is made of a material and has a design such as its optical parameters are more sensible to a modification of the process parameter that the usual manufactured lenses.

Advantageously, the use of a master lens makes the correlation between a shift in the positioning error and a parameter of the manufacturing device used during the lens manufacturing process easier and more reliable.

For example, the master lens may be manufactured daily or several times per day or a regular basis not every day so as to check the parameters of the manufacturing device.

The invention has been described above with the aid of embodiments without limitation of the general inventive concept.

1. A method of manufacturing an optical lens, the method comprising:
a lens member providing step during which a lens member comprising a first surface and a first reference system of the first surface is provided, the first reference system being identified by first markings on the first surface;
a surface data providing step during which surface data corresponding to a second surface and the position of the second surface relative to the first surface of the optical lens to be manufactured are provided;
a lens member blocking step during which the lens member is blocked in a machining position;
a machining step during which the second surface of the optical lens is machined according to the surface data;
a second markings determining step during which second markings identifying a second reference system of the second surface are determined according at least to optical data representing the refractive properties of the optical lens and to observation data representing observation conditions in which the first and second markings are to be observed; and
a second markings providing step during which the second markings are provided on the second surface of the optical lens.

2. The method according to claim 1, wherein the method further comprises:
an reference system determining step during which the first and second reference systems are determined by determining the positions of the first and second markings in the observation conditions corresponding to the observation data; and
a comparison step during which the positions of the first and second reference systems are compared so as to determine the positioning error between the first and second surfaces.

3. The method according to claim 2, wherein the method further comprises a sorting step during which the manufactured optical lens is accepted if the positioning error between the first and second surfaces is smaller than or equal to a threshold value and is set aside if the positioning error between the first and second surfaces is greater than said threshold value.

4. The method according to claim 2, wherein during the reference system determining step the positions on the first and second markings are measured using a measuring optical device and the observation data represents at least the position of the optical lens relative to the measuring optical device.

5. The method according to claim 2, wherein during the reference system determining step, the relative position between the first and second markings is determined in the observation conditions by an operator.

6. The method according to claim 1, wherein during the second marking determining step the second markings are determined so as to appear at the same position as the first markings in the observation conditions when the second surface is correctly positioned relatively to the first surface.

7. The method according to claim 1, wherein during the second marking determining step the second markings are determined so as to take into account a positioning error tolerance.

8. The method according to claim 1, wherein the optical data represent at least the design of the first and second surfaces and the relative position of the second surface relative to the first surface.

9. The method according to claim 1, wherein during the second markings providing step the optical lens is blocked in the same position as during the machining step.

10. The method according to claim 1, wherein the first and/or second markings are temporary markings.

11. The method according to claim 1, wherein the optical data represent at least the prescription of the wearer for which the optical lens is manufactured.

12. A method for controlling a lens manufacturing process comprising:
an optical lens manufacturing step during which an optical lens is manufactured according to a manufacturing method as claimed in claim 1 using a manufacturing device,
a positioning error determining step during which the positioning error of the first and second surfaces of the optical lens is determined;
a recording step during which the positioning error is recorded; and
repeating regularly optical lens manufacturing, positioning error determining and recording steps and checking the evolution of the positioning error over time, and the evolution of at least one parameter of the manufacturing device used during the lens manufacturing process is checked over time and the evolution over time of the positioning error of the first and second surfaces of the optical lens is related with the evolution over time of the at least one parameter of the manufacturing device.

13. A method for controlling a lens manufacturing process comprising:
a master lens manufacturing step during which a master lens is manufactured according to a manufacturing method as claimed in claim 1 using a manufacturing device,
a positioning error determining step during which the positioning error of the first and second surfaces of the master lens is determined;
a recording step during which the positioning error is recording; and
repeating regularly master lens manufacturing, positioning error determining and recording steps and checking the evolution of the positioning error over time, and the evolution of at least one parameter of the manufacturing device used during the lens manufacturing process is checked over time and the evolution over time of the positioning error of the first and second surfaces of the master lens is related with the evolution over time of the at least one parameter of the manufacturing device.

14. A computer program product comprising one or more stored sequences of instructions that are accessible to a processor and which, when executed by the processor, causes the processor to carry out the steps of claim 1.

15. A computer readable medium carrying one or more sequences of instructions of the computer program product of claim 14.

16. A computer program product comprising one or more stored sequences of instructions that are accessible to a processor and which, when executed by the processor, causes the processor to carry out the steps of claim 12.

17. A computer readable medium carrying one or more sequences of instructions of the computer program product of claim 16.

18. A computer program product comprising one or more stored sequences of instructions that are accessible to a processor and which, when executed by the processor, causes the processor to carry out the steps of claim 13.

19. A computer readable medium carrying one or more sequences of instructions of the computer program product of claim 18.
